(19) United States
(12) Patent Application Publication
(10) Pub. No.: US 2005/0122959 A1
(43) Pub. Date: Jun. 9, 2005

(54) Enhanced telecommunication system

(76) Inventors: Lewis S. Ostrover, Los Angeles, CA (US); Spencer Stephens, Toluca Lake, CA (US); Chris R. Odgers, Clarement, CA (US); Massimiliano Gasparri, Los Angeles, CA (US)

Correspondence Address: GOTTLIEB RACKMAN & REISMAN PC, 270 MADISON AVENUE, 8TH FLOOR, NEW YORK, NY, 100160601, US

(21) Appl. No.: 10/729,459

(22) Filed: Dec. 5, 2003

(51) Int. Cl. H04L 12/66

(52) U.S. Cl. 370/352; 370/466

(57) ABSTRACT

An enhanced telephone system provides a communication channel between a telephone associated with a customer and a party using another telephone. The system includes a mediator server. The mediator server monitors conversations and when a predetermined event is detected, for example, when the customer terminates a conversation, a message is sent to the other telephone, and optionally, to the customer's telephone as well. The message includes an audio clip, and optionally other elements, such as graphics and alphanumeric characters.

### BACKGROUND OF THE INVENTION

1. Field of Invention

This invention pertains to a telecommunication system with telephones that can selectively insert pre-recorded sound clips or other types of messages into conversations.

2. Description of the Prior Art

Conventional telephones announce incoming calls by a plain ringing tone. Recently many telephones, especially cellular telephones, have become available that provide various other types of ringing tones, as well as other types of sounds including various musical selections and special sound effects. Typically, these sounds are stored by the telephones as digital sound files or clips. These files can be pre-loaded into the telephone by the manufacturer or can be recorded and downloaded by a customer.

Cellular telephones can also take advantage of other services that handle sound files. For example, services such as SMS(Short Message Service) and MMS (Multimedia Message Service) use the Wireless Application Protocol (WAP) protocol to send text messages and other types of digital files containing multimedia content including graphics, video clips and sound clips. These digital files can be pre-loaded into a device, such as a cellular telephone, by the manufacturer, or can be authored by the customer.

There is a need for an enhanced telecommunication system that is capable of providing audio and/or text messages with useful content.

### SUMMARY OF THE INVENTION

An enhanced telephone system constructed in accordance with this invention, provides a communication channel between a telephone associated with a customer and a party using another telephone. The system includes a mediator server. The mediator server monitors conversations and when a predetermined event is detected, for example, in the middle or at the end of a conversation, a message is sent to the other telephone, and optionally, to the customer's telephone as well. The message includes an audio clip, and optionally other elements, such as graphics and text.

In one embodiment, the contents of the messages are fixed and preselected. In another embodiment, the content of the messages can be changed dynamically.

A single message may be sent to several parties, or different messages may be sent to different parties.

The mediator server may also be provided with several modules that can convert messages from one format to another, as required.

The invention may be used in cellular telephones, land-based telephones, or devices providing voice communication via the Internet.

### BRIEF DESCRIPTION OF THE DRAWINGS

FIG. 1 shows a block diagram illustrating a telecommunication system constructed in accordance with this invention;

FIG. 2 shows a flow chart for a telephone conversation using the system of FIG. 1;

FIG. 3 illustrates the elements of the telephone conversation on the system of FIGS. 1 and 2;

FIG. 4 shows a flow chart for generating an MMS message dynamically by the system of FIG. 1; and

FIG. 5 shows an implantation for the subject invention using a voice-over-IP device.

### DETAILED DESCRIPTION OF THE INVENTION

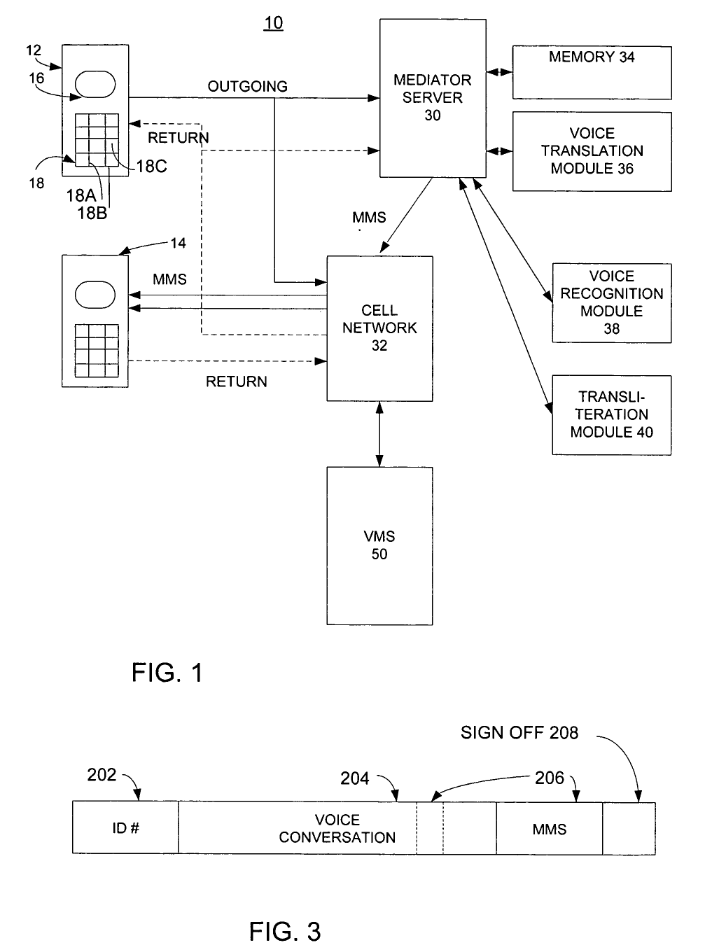

An enhanced telecommunication system 10 constructed in accordance with this invention is shown in FIG. 1. In this system, a customer with telephone 12 can converse with, or send messages to another party using a cellular or land-based telephone 14. Telephone 14 can, but need not be part of the system 10.

Cellular telephone 12 includes a display 16 and a keypad 18 with a plurality of dialing or control pushbuttons used by a customer to operate the cellular telephone 12 in the normal manner.

The system 10 further includes a mediator server 30 and a cellular network 32. The mediator server 30 is connected to one or more modules, such as a memory module 34, a voice translation module 36, a voice recognition module 38 and a transliteration module 40. The function of these modules is explained below.

The cellular network 32 provides standard telephone service for cellular telephone 12 and other telephones within the system 10.

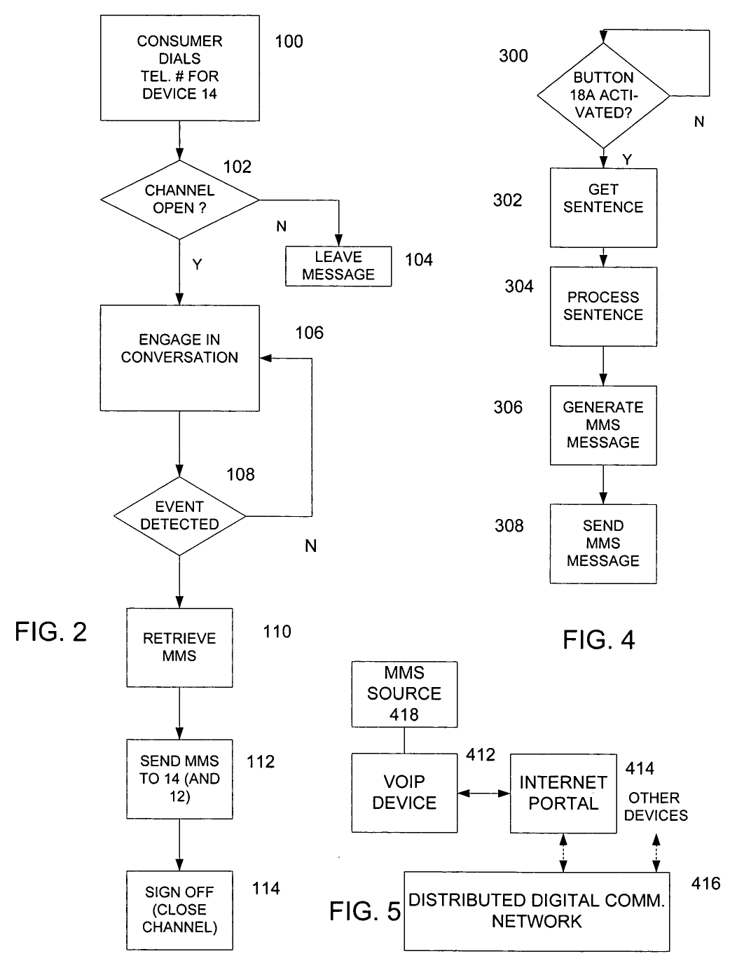

The method for performing a typical conversation through system 10 is now described in conjunction with the flow chart of FIG. 2. In step 100 the customer dials the number of telephone 14. All signals between the telephone 12 can be passed to the mediator server 30, which then sends them to the cellular network 32. However, preferably, the signals from the telephone 12 are intercepted (since they are radio transmissions, anyway) by both the server 32 and the mediator 30. The cellular network 32 then contacts telephone 14 and tries to open a communication channel between telephones 12 and 14 (step 102). If, the channel cannot be established, the customer can leave a voice message using voice message server 50 (as discussed in more detail below).

Once the communication channel is opened, the two parties can engage in a conversation (step 106) in a conventional manner. The conversation is performed in full duplex mode with the outgoing signals being transmitted from the telephone 12 through the cellular network 32 to the telephone 14. The return signals from the telephone 14 (indicated by dashed lines) are transmitted through the cellular network 32 to the telephone 12.

The mediator server 30 detects a predetermined event, as discussed in more detail below. When this event is detected, the mediator server 30 retrieves a preselected MMS from memory 34 (step 110) and sends it to telephone 14 (step 112) and, optionally, to telephone 12. At the end of the conversation, when the user signs off on telephone 12. The channel between the two telephones is then closed (step 114).

FIG. 3 shows the content of a typical conversation 200 between the telephones 12 and 14. As discussed above, it starts off with the transmission of the number of telephone 14 during period 202. Once the channel is established, the two parties engage in conversation during period 204. While this conversation is occurring, the user of telephone 12 can activate a predetermined key on the keypad 18 (or a sequence of keys). When the mediator server 30 detects this event, it causes the respective MMS message to be sent. This message is imbedded in the conversation, as indicated in FIG. 3 by the dashed lines. In addition, or alternatively, the system can be adapted so that the MMS message 206 is sent at the end of the conversation (during the so-called ring-off period). In this embodiment, the server 30 detects that the user of telephone 12 has signed off. A typical cellular telephone system may require that at the end of the message, the telephone 12 send out a sign-off signal. In system 10, this sign-off signal can be generated either by the server 30 or by telephone 12. Of course, the sign-off signal has to be generated after the MMS message 206 because, otherwise, the MMS message 206 may not be received by the telephone 14. Alternatively, the message 206 may be sent first to telephone 12 which then can readily incorporate it into the conversation.

The mediator server 30 is shown as a separate component of the system 10, however, all or parts of it may be incorporated into the telephone 12.

In the simplest embodiment of the invention, the MMS message can be a small audio or video clip from a known artist, a feature movie, a music video, a cartoon, etc. The clip can be generated by the user, downloaded through the Internet and into the telephone 12, purchased from a commercial vendor, etc. The prerecorded audio clip may be a voice message recorded by the customer using his own voice, may be a musical selection, or could be special sound effect, such as a door bell.

The system may be provided with several additional options to enhance or modify its mode of operation. For example, in the embodiment disclosed above, the contents of the MMS message are preselected by the customer of the telephone 12. That is, for every predetermined event, a preselected MMS message is sent out. The mediator server 30 can be provided with a plurality of MMS messages in its memory 34, each message being associated with one or more telephones. In this manner, a first MMS message may be sent when a call is made to a first telephone, a second MMS message may be sent when a call is made to a second telephone, and so on. In this embodiment, the customer using telephone 12 preselects a specific MMS message for each telephone number that he calls. The mediator server 30 then generates and stores in its memory 34 a list associating each of a plurality of telephones with a specific MMS message. One of the MMS messages may be designated to any telephone called from telephone 12 that is not on the list. The mediator server 30 can also be set to pick a random MMS and send it either to unlisted telephones, or, alternatively, to any telephone, whether listed or not.

The MMS message(s) can be sent simultaneously to several other parties, for example, during or at the end of a conference call. In one embodiment, all the parties can get the same message. In another embodiment, each party can get a different MMS message.

In all of these embodiments, the contents of the MMS messages are preselected. However, the system can also accommodate messages that are dynamically generated. For example, at the end of a conversation, the customer can activate a specific pushbutton sequence and utter an arbitrary or random sentence. When the mediator server determines that the pushbutton sequence has been activated, it modifies the sentence in a predetermined manner and generates a corresponding MMS message. FIG. 4 shows the process for performing this function. In step 300, the mediator server 30 monitors the telephone 12 for the pushbutton sequence In step 302 the mediator server 30 receives the arbitrary sentence. In step 304 the arbitrary sentence is processed as discussed below. In step 306 the processed sentence is converted into an MMS message. In step 308 the MMS message is sent out in the manner described in FIGS. 1 and 2.

The processing step 306 can include various different types of operations. For example, a voice modification filter can be used to transform the voice of the customer. As a result, the processed message consists of the words uttered by the customer but in the voice of a cartoon character, a famous personality, etc.

Alternatively, the mediator server 30 can be coupled to, or provided with a translator module 36. The translator module 36 translates the words from the customer into a corresponding phrase in a different language. Thus, if the customer normally talks in English, the processed words could be in French, Spanish, Chinese, etc.

The mediator server 30 can also be set to process the words from the customer into a different media. More particularly, in the examples given above, the customer utters spoken words and the mediator server 30 can be associated with a speech recognition module 38 that recognizes the spoken words and converts them into alphanumeric written characters. Thus, the MMS message generated is a written, rather than a spoken message. Conversely, the customer, rather then speaking the words, can enter them on the telephone 12 (which, at least for this embodiment must be equipped with a keyboard, other means of entering text, or handwriting recognition means). For this embodiment, the mediator server 30 is provided with a transliteration module 40 that transforms the written words into spoken words. The spoken words thus generated are then used for the MMS message.

In the description of FIGS. 1 and 2 it has been assumed that a channel is established immediately with telephone 14. In some instances, the party using the telephone 14 may not be available, or the telephone 14 could be off, or out of range. For these situations, a voice mail server (VMS) 50 is provided to allow the customer to leave a voice message. The customer using phone 12 can leave a regular voice message and the MMS message, or only the MMS message on this voice mail server 50. The message(s) are then delivered to the phone 14 at a later time in the usual manner.

The system 10 is further configured to provide other functions for situations in which the customer using telephone 12 is unable to engage in a regular conversation with another party. For these occasions, the mediator server 30 is programmed to assemble a conglomerate message and send it automatically to the other party. For example, if the customer is at a meeting and he gets a call from the other party, he depresses a sequence of three pushbuttons 18A, 18B, 18C, all part of the keypad 18. In response, the telephone 12 generates several signals to the calling party. The first signal alerts the mediator server 30 that a conglomerate message must be generated. The second signal designates the type of message that is to be sent. The message may be “I busy right now. I will call you back soon.” Optionally, the message may include a blank portion that has to be filled in by a variable voice or audio clip. If the selected message does include a blank portion, a third signal is sent to the moderator designating the voice clip for filling in the blank period. For example, the message designated by the second signal may be “I am busy right now. I will call you in ______ minutes” and the third signal is then used to designate the voice clip to be introduced in the blank portion of the message. The voice clip may be “5 minutes,” “15 minutes,” “one hour,” etc.

A message with a blank period may also be initiated by the customer. For example, as the customer is driving home, he can depress a series of pushbuttons on telephone 12, causing a message to be sent home. One such message could be “I am on the road, I will be home in 35 minutes” where “35” is a variable selected by the customer and imbedded in the message as described above. Alternatively, instead of the customer generating it, the variable voice clip may be generated automatically by another means. For example, the mediator server 30 can be preprogrammed to determine the location of both parties, for example using GPS information, or from the cell that is servicing cellular telephone 12. The mediator server 30 then determines the approximate time that it will take for the customer to reach the location of the other party. The location of the other party may be preselected by the customer.

The variable content message generated by mediator server 30 can be in the voice of the customer, or a generic voice may be used. In this latter instance, a table is set up so that the mediator server 30 receives a request to send a message from a customer, the mediator server 30 looks up the name of the customer and incorporates it into the message. So one message can say “Mr. Smith is at a meeting and will call you back in 20 minutes” while another message may say “Mr. Jones is on his way home and will be there in one hour.” As can be seen from these examples, messages may have two or more blank periods that are filled by voice clips.

Some of the messages discussed above may include graphic elements such as pictures of actual people or cartoon characters. If a message includes both graphic elements and sound clips, the graphic elements may be modified simultaneously or in synchronism with the sound clip, for example, by changing facial expressions.

The invention was described as being part of and in conjunction with a cellular telephone system. However, it is equally applicable to other systems, such as systems with land based (wired or wireless) telephones, and other types of devices, such as Internet communication devices that allow conversations over the Internet using, for example, voice over the Internet Protocol (VOIP). As shown in FIG. 5, for this latter implementation, an MMS message source 418 is provided which can generate messages for various parties, as discussed above. The source 418 may include the mediator server and various other components shown in FIG. 1. Conversations take place over the VOIP device 412 that is connected to an Internet portal 414 to a distributed digital communication network 416. Communication between the device 412 and portal 414 may take place through a dial-up telephone modem, a cable modem, a DSL modem, etc. Device 412 may be implemented as a card inserted into a PC or other similar computer, or may be stand-alone device. Both arrangements are available from several companies, such as Net2Phone of Newark, N.J. Conversations can be conducted from the device 412 to other devices including VOIP devices, land-based telephones, cellular telephones, etc. The MMS source 418 can be a separate device, or can be incorporated in the device 412.

While the invention has been described with reference to several particular embodiments, it is to be understood that these embodiments are merely illustrative of the principles of the invention. Accordingly, the embodiments described in particular should be considered as exemplary, not limiting, with respect to the following claims.

1. A telephone system comprising:
a first telephone;
a network selectively providing a voice channel to another telephone to allow a conversation between said first and said another telephone; and
a mediator server associated with the network and generating a predetermined message to said another telephone when an event associated with the conversation is detected.

2. The telephone system of claim 1 wherein said mediator server is incorporated in the first telephone.

3. The telephone system of claim 1 wherein said mediator server generates one of a voice, a graphic and an alphanumeric message.

4. The telephone system of claim 1 wherein said mediator server is associated with a memory, said memory storing a plurality of messages in a predetermined format.

5. The telephone system of claim 1 wherein said mediator server generates a message with blank period, with said blank period being filled in with content designated by the user of the first telephone.

6. A telephone system comprising:
a first telephone that defines an audio channel to another telephone for a conversation; and
a mediator server associated with the first telephone, said mediator server generating a message when either the user terminates a conversation on the telephone, or the user causes said telephone to generate a predetermined command.

7. The telephone system of claim 6 wherein said mediator server generates one of an audio message, a graphic message and an alphanumeric message.

8. The telephone system of claim 6 further comprising a processing member adapted to receive a message in one format and generates a corresponding message in a different format.

9. The telephone system of claim 6 wherein said telephone generates commands and said mediator server generates said message in response to said commands.

10. The telephone system of claim 9 wherein said telephone generates commands in response to an incoming call.

11. The telephone system of claim 9 wherein said telephone generates commands in response to actions by the user.

12. The telephone system of claim 6 wherein said mediator server generates a message having a standard portion and a blank period and wherein said mediator server fills in said blank period with variable content.

13. The telephone system of claim 6 wherein said telephone is a cellular telephone.

14. The telephone system of claim 13 further comprising a cellular network providing cellular telephone service to said telephone.

15. The telephone system of claim 6 wherein said first telephone establishes conversations using a VOIP protocol.

16. A method of conducting a telephone conversation comprising:
establishing an audio channel between two telephones;
generating in response to a predetermined event a message; and
sending said message to at least one of said telephones.

17. The method of claim 16 wherein said predetermined event is the activation of a pushbutton at one of said telephones.

18. The method of claim 16 wherein said predetermined event is the termination of the conversation at one of said telephones.

19. The method of claim 16 further comprising receiving a voice signal from one said telephones and processing said voice signal to generate said message.

20. The method of claim 19 wherein said processing includes translating said voice signal into a message in a different language.

21. The method of claim 16 further comprising receiving a signal in one format from one of said telephones and processing said signal to generate said message in a different format.

22. The method of claim 21 wherein a voice signal is generated from one of said telephones and an alphanumeric message is generated from said voice message.

23. The method of claim 21 wherein a text signal is generated from one of said telephones and a corresponding voice message is generated.

24. The method of claim 21 wherein a voice signal is generated in a first language and said voice message is translate a different messages.

25. The method of claim 16 further comprising generating a message having a fixed portion and variable portion.

26. The method of claim 16 wherein conversation is established between said telephone using voice over Internet protocol.

27. The method of claim 16 further comprising establishing conversation between the telephones using an Internet communication device.
